(19) United States
(12) Patent Application Publication
(10) Pub. No.: US 2026/0289452 A1
(43) Pub. Date: Sep. 24, 2026

(54) TECHNOLOGIES FOR MANAGING OPERATIONAL RISK IN A COMPUTING PLATFORM INFRASTRUCTURE

(71) Applicant: DK CROWN HOLDINGS INC., Boston, MA (US)

(72) Inventors: David A. Covino, Derry, NH (US); Benjamin Lieberman, Boston, MA (US); Charles Arnaudo, Wells, ME (US)

(21) Appl. No.: 19/086,641

(22) Filed: Mar. 21, 2025

(51) Int. Cl. G06Q 10/0631

(52) U.S. Cl. CPC G06Q 10/06314

(57) ABSTRACT

Techniques for managing resource optimization tools on a cloud-based platform (e.g., an online sportsbook platform) include a computing system that retrieves schedule data associated with events (e.g., sport events). The system predicts, based on the schedule data, events having a likelihood of increasing user traffic to a platform, in which the platform has resource optimization tools configured to optimize resource utilization on the platform. Time windows associated with each of the predicted events are identified, and configuration parameters of the resource optimization tools are modified to adjust operation of the tools during the identified time windows.

### BACKGROUND

In a cloud-based computing environment, balancing cost efficiency with operational stability during periods correlating to critical revenue periods is a known challenge. For instance, some computing platforms benefit from high user engagement while concurrently also needing to dynamically adjust computing resources based on present and expected traffic. Resource optimization tools allow cloud-based computing environments to automate allocation of resources (e.g., computing nodes, processing resources, network resources, etc.) based on specified needs. For example, resource optimization tools may provision and deprovision computing nodes in the environment based on usage, network load, and cost. However, although resource optimization tools have been effective in reducing risk relative to the computing environment, reactive infrastructure adjustments can introduce undesirable service disruptions that impact stability and reliability.

### SUMMARY

Embodiments presented herein disclose techniques for managing infrastructure component behavior based on forward-looking data (e.g., event-based data) within a cloud-based infrastructure.

One embodiment disclosed herein generally includes a system having one or more processors and a memory. The memory stores instructions, which, when executed on the processors, causes the system to retrieve schedule data associated with events. Each event occurs between a future start time and end time. The system predicts, based on the schedule data, one or more of the events having a likelihood of increasing user traffic to a platform having at least one resource optimization tool configured to optimize resource utilization on the platform. The system identifies a time window associated with each of the predicted one or more events. The system modifies one or more configuration parameters of at least one resource optimization tool to adjust operation of the resource optimization tool during the identified time windows.

Another embodiment disclosed herein generally includes a computer-readable storage medium storing instructions. When executed by one or more processors, the instructions cause a system to retrieve schedule data associated with events. Each event occurs between a future start time and end time. The system predicts, based on the schedule data, one or more of the events having a likelihood of increasing user traffic to a platform having at least one resource optimization tool configured to optimize resource utilization on the platform. The system identifies a time window associated with each of the predicted one or more events. The system modifies one or more configuration parameters of at least one resource optimization tool to adjust operation of the resource optimization tool during the identified time windows.

Yet another embodiment disclosed herein generally includes a method. The method generally includes retrieving, by one or more processors, schedule data associated with a plurality of events, each event occurring between a future start time and end time. The method also generally includes predicting, based on the schedule data, one or more of the plurality of events having a likelihood of increasing user traffic to a platform having at least one resource optimization tools configured to optimize resource utilization on the platform.

### BRIEF DESCRIPTION OF THE DRAWINGS

The foregoing aspects and other features of the disclosure are explained in the following description, taken in connection with the accompanying example drawings relating to one or more embodiments.

FIG. 1 illustrates an example computing environment in which dynamic resource optimization tools manage resources in a cloud-based infrastructure such as an online sportsbook platform;

FIG. 2 further illustrates an example server in the online sportsbook platform of FIG. 1;

FIG. 3 illustrates a conceptual block diagram of an example operational environment for the online sportsbook platform of FIG. 1;

FIG. 4 illustrates a block diagram of components of an example dynamic scheduling service for managing behavior of resource optimization tools on the online sportsbook platform of FIG. 1;

FIG. 5 illustrates a flow diagram of an example method for configuring a dynamic scheduling service for managing behavior of resource optimization tools; and

FIG. 6 illustrates a flow diagram of an example method for managing behavior of resource optimization tools in a cloud-based infrastructure.

### DETAILED DESCRIPTION

Generally, cloud-based platform environments provide techniques to manage resource allocation during various periods of operation. For example, resource optimization tools dynamically reconfigure computing resources for a given platform infrastructure based on demand and user-defined configurations to maintain an efficient, stable, and scalable environment. Such tools can scale up computing clusters within the platform infrastructure to provide additional capacity based on workload requirements, current resource consumption, and user-defined policies. In doing so, the platform may incur additional costs associated with provisioning cluster nodes. Such tools may also apply aggressive resource management to achieve peak efficiency. For instance, the tools may be configured to perform “bin-packing” (e.g., assigning a high density of pods or running processes to a single node) for periods of low demand to save costs though at the tradeoff of application performance degradation from heightened resource utilization within the node (e.g., increased CPU, memory, I/O scheduling times, etc.).

However, continued infrastructure adjustments (e.g., adjustments made by resource optimization tools) for a cloud-based platform can inadvertently disrupt operations in the platform, such as during unanticipated periods of extremely high user traffic. For instance, a sudden spike in traffic during a period in which the infrastructure is optimized for cost efficiency may adversely impact revenue to the platform due to dense allocations of processes to a single node affecting application performance (and consequently, user experience). For example, in an online sportsbook platform that allows users to engage with sports events by making various type of bets, traffic to the platform may sharply increase during popular events, which can correlate to high user engagement and revenue potential for the platform. During such periods, resource optimization tool behavior may potentially disrupt meaningful user interaction with the platform (e.g., bet placements, social media engagement, live streaming, etc.) with degraded performance and downtime of the underlying processes and services.

Embodiments presented herein disclose technologies for managing operational risk during critical periods (e.g., caused by resource optimization tool behavior) in a cloud-based infrastructure. As further described herein, the disclosed technologies provide a dynamic scheduling service that adjusts behavior of infrastructure components (e.g., an aggressiveness of existing resource optimization tools for the platform infrastructure) based on predicted periods of time during which the platform is anticipated to experience risk to high revenue periods for the platform such as during increased amounts of user traffic. For example, in the online sportsbook platform discussed above, the dynamic scheduling service of the present disclosure may obtain real-time schedules of events that correlate to high user traffic to the platform, such as major sports league games, boxing matches, esports events, and so on. The dynamic scheduling service, given the data, may predict user activity and resource expectations during time windows associated with the event schedules. Based on the predictions, the dynamic scheduling service may modify behavior of infrastructure components such as resource optimization tools to mitigate risk of service disruption during critical periods. For example, the dynamic scheduling service may tune bin-packing density parameters of certain resource optimization tools for critical periods to manage risk tolerance of density within individual cluster nodes. As another example, the dynamic scheduling service may tune an aggressiveness by which the resource optimization tools provision and deprovision nodes in critical periods to minimize service degradation in the platform.

Advantageously, the disclosed technology further aligns infrastructure components such as existing resource optimization tools (e.g., third-party resource optimization tools such as Amazon Web Services (AWS) Karpenter, ScaleOps, Goldilocks, etc.) with platform demands and user-defined resource utilization policies. By predicting windows of time in which critical revenue periods are at risk (e.g., peak user engagement) for a cloud-based platform using event scheduling data (among other data) and modifying resource optimization configurations based on the predicted windows, the dynamic scheduling service of the present disclosure provides an improvement to the infrastructure components such as the resource optimization tools, thus resulting in an improvement to the performance of computing systems within the platform overall.

Note, the present disclosure uses an online sportsbook platform as a reference example of a software computing environment that predicts periods of risk correlating to critical revenue periods of user engagement (e.g., high network traffic to the platform as a result of a sports event or promotion) within a cloud-based infrastructure based on forward-looking external and/or platform-driven data such as event scheduling data. Of course, one of skill in the art will recognize that the embodiments disclosed herein may be adapted to a variety of other software platforms in which identifiable events occur, such as online ticket sales and distribution sites, ecommerce platforms, content streaming sites, and so on.

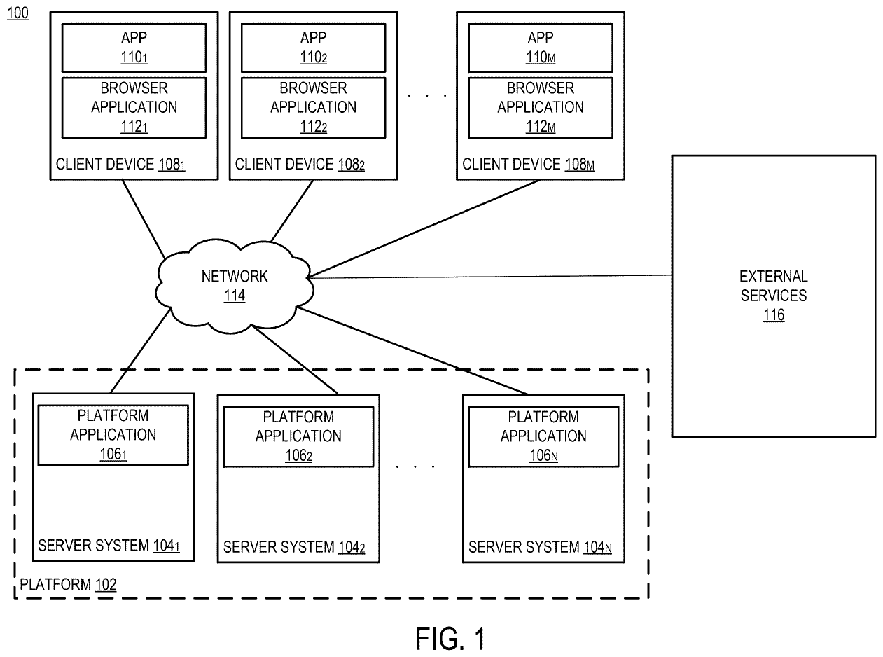

Referring now to FIG. 1, an example computing environment 100 is provided. As shown, the computing environment 100 includes a platform 102 which includes server systems 104_{1-N}. The computing environment 100 further includes client devices 108_{1-M} and external services 116. Each of the server systems 104, client devices 108, and external services 116 are interconnected via a network 114, such as the Internet.

In an embodiment, the server systems 104 of the platform 102 relate to computing resources used to provide a sports entertainment and gaming platform executing one or more services, such as an online sportsbook service, fantasy sports service, casino service, and the like. The services may execute via one or more platform applications 106_{1-N}. A server system 104 may be embodied as a physical computing system or a virtual computing instance executing in a cloud environment. The server systems 104 may be physically and/or logically grouped to provide the one or more services via the platform applications 106_{1-N}.

Client devices 108_{1-M} may access the platform applications 106_{1-N} through a variety of means, such as through a platform-specific app 110 or through a web interface via a browser application 112. Via the app 110 (or the web interface), a user of the platform may access a sportsbook service provided by the platform applications 106_{1-N} to place bets on various sporting events. For example, the user may place a moneyline or spread bet on an outcome of a football game taking place on a given date. As another example, the user may place a parlay bet on a number of outcomes occurring across multiple sporting events. The app 110 may also provide social media functions such as a user feed to allow users to interact with one another regarding sports events and share betting activity. A client device 108 may be embodied as a physical computing system (e.g., a desktop computer, laptop computer, mobile device such as a smartphone or tablet, etc.) or a virtual computing instance executing on a cloud provider network.

In an embodiment, the external services 116 may correspond to endpoint servers of entities that may engage with the platform 102 via one or more application programming interfaces (APIs). An example external service 116 may correspond to a third-party social media network service that uses the APIs provided by the platform 102 to perform functions such as retrieving sportsbook data to be shared on the profile of a user of the social media network. Another example third-party service 116 may correspond to a marketing channel that generates content (e.g., newsfeed posts, banner images, event scheduling data, etc.) based on data retrievable from the platform 102.

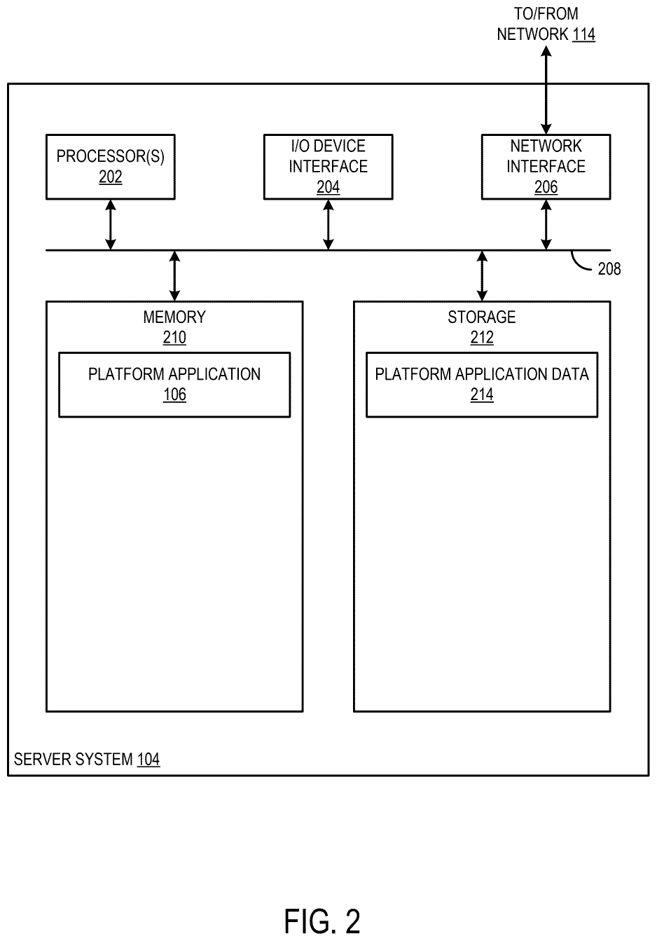

Turning briefly to FIG. 2, a block diagram further illustrating hardware and software components of an example server system 104 is shown. As shown, the server system 104 includes, without limitation, one or more processors 202, an I/O device interface 204, a network interface 206, a memory 210, and a storage 212, each interconnected via a hardware bus 208. Of course, the actual server system 104 will include a variety of additional hardware (or software-based) components not shown. Additionally, in some embodiments, one or more of the illustrative components may be incorporated in, or otherwise form a portion of, another component.

The processor 202 retrieves and executes programming instructions stored in the memory 210 capable of performing the functions described herein. The processor 202 may be embodied as a single or multi-core processor(s), a graphics processor, a microcontroller, or other processor or processing/controlling circuit. In some embodiments, the processor 202 may be embodied as, include, or be coupled to a field programmable gate array (FPGA), an application-specific integrated circuit (ASIC), reconfigurable hardware or hardware circuitry, or other specialized hardware to enable performance of the functions described herein. The hardware bus 208 is used to transmit instructions and data between the processor 202, storage 212, network interface 206, and the memory 210. The memory 210 may be embodied as any type of volatile (e.g., dynamic random access memory, etc.) or non-volatile memory (e.g., byte addressable memory) or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces.

The network interface 206 may be embodied as any hardware, software, or circuitry (e.g., a network interface card) used to connect the server system 104 over the network 114 and providing the network communication component functions described above. For example, the network interface 206 may be embodied as any communication circuit, device, or collection thereof, capable of enabling communications over the network 114 between the server system 104 and other devices. The network interface 206 may be configured to use any one or more communication technology (e.g., wired, wireless, and/or cellular communications) and associated protocols (e.g., Ethernet, Bluetooth®, Wi-Fi®, WiMAX, 5G-based protocols, etc.) to effect such communication. For example, to do so, the network interface 206 may include a network interface controller (NIC, not shown), embodied as one or more add-in-boards, daughtercards, controller chips, chipsets, or other devices that may be used by the server system 104 for network communications with remote devices (e.g., client devices 108, endpoint servers executing external services 116). For example, the NIC may be embodied as an expansion card coupled to the I/O device interface 204 over an expansion bus such as PCI Express.

The I/O device interface 204 allows I/O devices to communicate with hardware and software components of the server system 104. For example, the I/O device interface 204 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O device interface 204 may form a portion of a system-on-a-chip (SoC) and be incorporated, along with one or more of the CPU/GPU 202, the memory 210, and other components of the server system 104.

The I/O devices (not shown) may be embodied as any type of I/O device connected with or provided as a component to the server system 104, such as keyboards, mice, and printers. Illustratively, the memory 210 includes the platform application 106, which is configured to, in part, receive event and promotion schedule data as well as other data that can be used to predict peak periods of traffic on the platform 102, predict risk windows (e.g., windows of time corresponding to peak traffic to the platform 102), determine adjustments to enact on resource optimization tools during the windows, and apply the adjustments by modifying configurations of the resource optimization tools during the predicted risk windows.

The storage 212 may be embodied as any type of device configured for short-term or long-term storage of data such as, for example, memory devices and circuits, memory cards, hard disk drives (HDDs), solid-state drives (SSDs), or other data storage devices. The storage 212 may include a system partition that stores data and firmware code for the storage 212. The storage 212 may also include an operating system partition that stores data files and executables for an operating system. As shown, the storage 212 includes platform application data 214. The application data 214 may be embodied as any type of data generated or maintained by the platform application 106, such as application service configurations, resource cluster and allocation configurations, event data, promotional data, etc.

In some embodiments, the platform 102 and services provided by the platform 102 may be implemented as a microservice architecture on a virtual machine or container-based cluster infrastructure. The infrastructure may provide components for deploying, scaling, and managing microservices and workloads. For example, the platform 102 may be implemented using a public open source cluster architecture such as Kubernetes. Other examples include, but are not limited to, Docker, Amazon ECS, and Azure Container Instances.

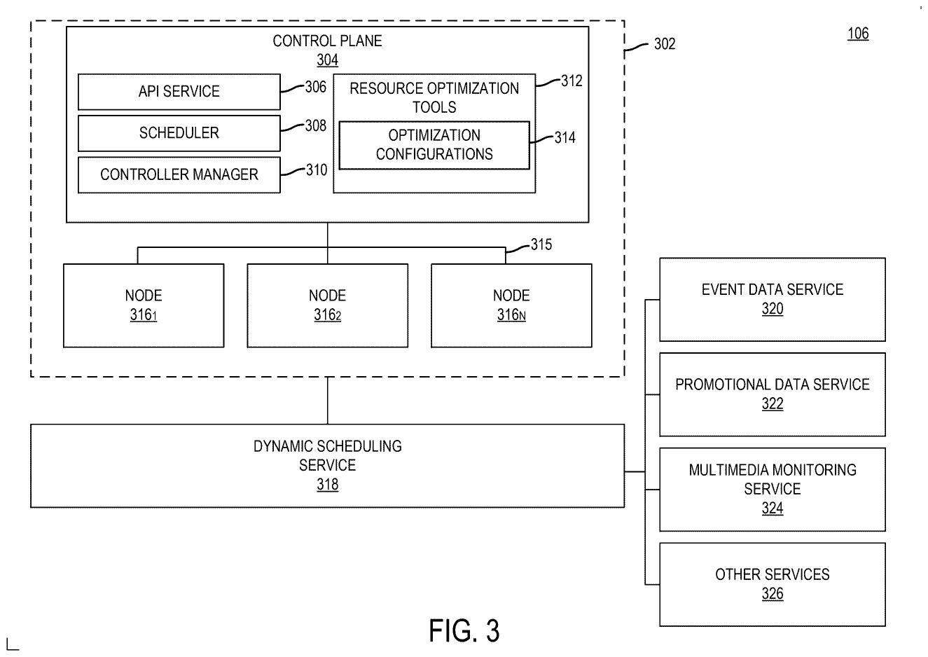

Referring now to FIG. 3, an example conceptual diagram depicting components of the platform application 106 is shown. The platform application 106 may include a cluster architecture 302, a dynamic scheduling service 318, an event data service 320, promotional data service 322, multimedia monitoring service 324, and other services 326. The cluster architecture 302 provides a control plane 304 that manages a node cluster 315 comprising one or more nodes 316_{1-N}.

The cluster architecture 302 automates deployment, scaling, and operation of microservices and other processes executed by the platform 102. The control plane 304 is a centralized management layer for orchestrating and managing node clusters in the platform 102. The nodes 316 may host components (also referred to herein as “pods”) of a workload for the application 106. The control plane 304 manages the nodes 316 to ensure that the cluster functions according to user policies (e.g., node affinity policies, resource allocation configurations, security policies, health and monitoring, etc.).

To do so, the control plane 304 includes an application programming interface (API) service 306, scheduler 308, controller manager 310, and one or more resource optimization tools 312. Although the control plane 304 is depicted herein as a single unit, the components (and sub-components thereof) of the control plane 304 may execute across multiple server systems.

The API service 306 exposes internal API of the control plane 304 for communication between components of the cluster architecture 302 and other components such as the dynamic scheduling service 318 and client devices 1081-N. For example, the API service 306 may process API requests from the scheduler 308, controller manager 310, and other processes (e.g., to create, retrieve, and modify cluster objects such as pods, services, and deployments). The scheduler 308 is configured to assign pods (e.g., containerized applications executing in the cluster 315) to nodes in the cluster 315 based on resource availability, constraints, user policies, and other factors. The controller manager 310 continuously monitors state of the cluster 315 and adjusts resources to a given configuration. To do so, the controller manager 310 may also manage various controllers (e.g., architecture-based controllers and cloud-based controllers, not shown) each responsible for handling a given type of object or cluster activity.

The illustrative resource optimization tools 312 integrate with the cluster architecture 302 to manage cost and resource usage efficiency based on defined resource requests and limits for containers. For example, the resource optimization tools 312 may include pod autoscalers, which dynamically adjusts a number of pods based on observed resource metrics (e.g., CPU, memory, I/O, etc.) and usage. Resource optimization tools 312 also include cluster autoscalers, which scale the number of nodes 316 in the cluster 315 based on workload demands for the pods and the application 106 and on cost considerations. Some resource optimization tools 312 may be native to the cluster architecture 302, though third-party tools can also be used.

The resource optimization tools 312 may operate according to optimization configurations 314. The optimization configurations 314 may include settings for dynamic scaling, resource provisioning, bin-packing, cost optimizations, fast provisioning, pod scheduling, pod scheduling, node optimization, and so on. The configurations 314 may provide tunable parameters used to adjust a degree to which the resource optimization tools 312 are to perform the configured settings. For example, the optimization configurations 314 may provide a Pod Disruption Budget (PDB) parameter for configuring a minimum number (or percentage) of pods for a given application 106 workload that must be available at any given time.

As another example, the optimization configurations 314 may include NodePool configurations, which may be used by resource optimization tools 312 such as AWS Karpenter to set constraints on nodes 316 and pods or workloads executing on the nodes 316. The NodePool configuration may allow users to specify scaling behaviors and dynamic provisioning of the nodes 316.

As another example, the optimization configurations 314 may enable a user to specify an aggressiveness that dynamic scaling should be performed. In some cases, the cluster architecture 302 may be configured to prioritize certain demands, such as cost efficiency, based on user-defined policies or monitored resource utilization. One issue that arises is that unexpected spikes in user traffic may affect operation of the cluster architecture 302 due to specified optimization configurations 314, which can impact performance of the application 106 and cause periods of downtime in one or more of the nodes 316.

In an embodiment, the dynamic scheduling service 318 is configured to adjust optimization configurations 314 to modify behavior of resource optimization tools 312 during predicted risk windows, such as in periods of peak traffic activity associated with high user engagement. To do so, as further described herein, the dynamic scheduling service 318 is configured to predict periods of peak traffic based on data provided by internal services of the platform 102, such as an event data service 320, promotional data service 322, multimedia monitoring service 324, and other services 326.

The services 320-326 may be embodied as hardware, software, and/or circuitry configured to provide (e.g., via a respective API) the data described herein. The event data service 320 may be configured to provide event schedules of interest for the platform 102. For example, the event data service 320 may provide schedules for sports event programs (e.g., matches, games, drafts, press conferences, etc.). For instance, the scheduling data may include relevant parties associated with a given sports event program, a date of the sports event program, duration of the program, and start and end times associated with the program. The scheduling data also indicate other information, such as whether the sports event program was televised, markets in which the sports event program is televised, whether the sports event program is subject to blackouts in select markets.

The data provided by the services 322-326 may be data that can also be correlated with possible high traffic periods (and possibly high revenue periods) for the platform 102. The promotional data service 322 may provide marketing campaign data such as descriptions of a given marketing campaign, a duration of the campaign, start and end dates of the marketing campaign. The multimedia monitoring service 324 may provide data relating to news articles pertaining to sports leagues and associated individuals, press releases pertaining to sports leagues and associated individuals (and other subjects of interest to users of the platform 102), social media activity relating to sports leagues and associated individuals (and other subjects of interest to users of the platform 102). Other services 326 may include other internal APIs used by the sportsbook platform 102 such as services providing data relating to sports league rankings, television ratings, athlete injury reports, betting activity within the platform 102, and so on. In an embodiment, the services 320-326 may use continuous predictive scaling to automatically update scheduling data. Doing so reduces risks associated with manually updating scheduling data through schedule-based scaling.

In addition to internal services, the dynamic scheduling service 318 may also predict peak traffic periods based on data obtained from external sources, such as sites and APIs associated with business partners, sport leagues, weather services, social media services, and social media influencers. Once predicted, the dynamic scheduling service 318 may modify optimization configurations 314 to mitigate any negative impact caused by operation of resource optimization tools 312 during peak periods.

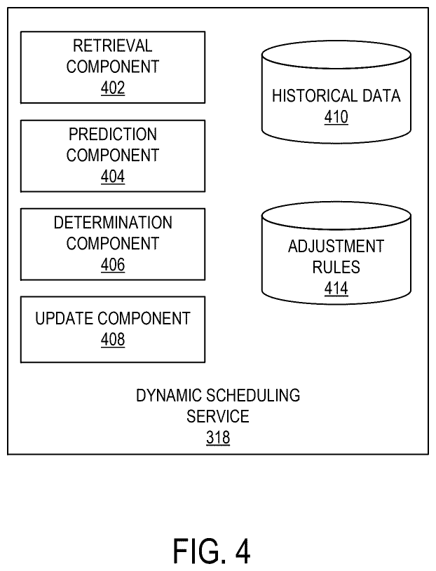

FIG. 4 illustrates components of the dynamic scheduling service 318. The dynamic scheduling service 318 includes a retrieval component 402, prediction component 404, determination component 406, update component 408, historical data 410, and adjustment rules 414. The components of the dynamic scheduling service 318 may be embodied as any software, hardware, and and/or circuitry configured to perform the functions described herein.

The illustrative retrieval component 402 is configured to obtain and process data for predicting peak periods of traffic in which the resource optimization tools 312 might impede operations of the platform 102. One example for doing so includes polling APIs of services 320-326 using formulated queries to asynchronously fetch scheduling data. The queries may include a date, identifiers that specify a given sports league, sports team, individual player, etc., and other parameters. The queried service (e.g., any of the services 320-326) may return scheduling data as a stream of events, in which each event can include parameters such as sports league, team names, date, starting time, ending time, an indicator of whether the event is televised, markets in which the event is televised, and so on. The retrieval component 402 may parse received scheduling data into discrete events.

The prediction component 404 is configured to identify events having a likelihood of increasing network activity in the platform 102, e.g., as a result of traffic corresponding to users engaging with the platform 102 (e.g., to place bets and monitor activity for a given event). The prediction component 404 is also configured to identify risk windows, such as periods of peak traffic correlating to high platform revenue and/or user engagement based on the retrieved events. The periods of traffic may be identified as time windows that incorporate the start and end times for a given event. For example, the time windows may include a buffer of time (e.g., five minutes, ten minutes, etc.) before the scheduled start times and/or after the scheduled end times. The prediction component 404 may also evaluate other parameters when identifying events that will likely correspond to a rise in user traffic to the platform 102 such as historical data 410. The historical data 410 may include betting activity, platform engagement, network traffic activity, television ratings, etc., associated with past events. The prediction component 404 may retrieve historical data 410 relating to a given event, such as bets, platform engagement, and resource utilization associated with previous matches between scheduled teams. In some embodiments, the prediction component 404 may positively weight events (e.g., by a specified factor) based on previous events if related historical data 410 is indicative of high user traffic during the previous events.

In some embodiments, the prediction component 404 may negatively weight (e.g., by a specified factor) events that are likely not to result in a sharp rise in user activity in the platform 102. Examples of events that might be negatively weighted include untelevised events, events that are televised in limited domestic markets, events involving teams that are lowly ranked or associated with low television ratings, events that have limited promotion or social media engagement, etc. In some embodiments, the dynamic scheduling service 318 may determine that a given event likely would not result in peak traffic to the platform 102 based on the negative weighting.

The determination component 406 is configured to evaluate an input window and determine one or more adjustments to perform on the optimization configurations 314, e.g., based on adjustment rules 414. The adjustment rules 414 may be embodied as any data specifying adjustments to be made to the optimization configurations 314 given specified conditions. For example, the adjustment rules 414 may specify a modification of Pod Disruption Budgets (or similar parameters such as minimum nodes to remain available during a disruption period) for a given node or group of nodes associated with a given workload or process such that the nodes remain available during a predicted risk window.

The update component 408 is configured to modify optimization configurations 314 based on the determined adjustments. Upon entering a time window, the update component 408 may retrieve relevant configurations 314 (identified by determined adjustments) and modify settings of the optimization configurations 314. The update component 408 may also modify settings of the optimization configurations 314 following exit of the time window.

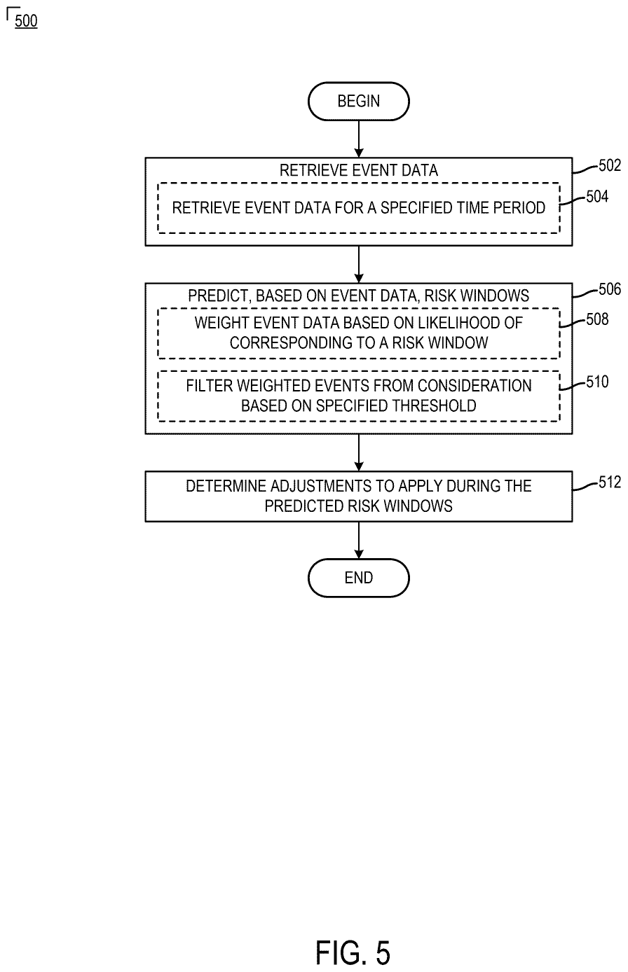

Referring now to FIG. 5, one or more of the server systems 104_{1-N} (for simplicity referred to herein as server system 104), in operation, may perform a method 500 for configuring parameters for managing behavior of the resource optimization tools 312 for anticipated risk windows (e.g., peak traffic periods). The method 500 may be performed by a variety of components of the server system 104, such as the platform application 106 and its components, such as the dynamic scheduling service 318 and resource optimization tools 312.

As shown, the method 500 begins in block 502, the server system 104 retrieves event data. For example, to do so, the dynamic scheduling service 318 may query the event data for one or more sports leagues for the day to obtain sports schedule data asynchronously. In block 504, the server system 104 may optionally retrieve event data for a specified time period, such as for a specified date or date range (e.g., sports event data for the upcoming week). The query for event data may also include other parameters, such as specific sports teams, individual athletes, markets, etc. In some embodiments, the dynamic scheduling service 318 may query other services of the platform 102 (e.g., promotional data service 322, multimedia monitoring service 324, other services 326, etc.) for additional data for use in predicting risk windows (e.g., peak traffic periods) for the platform 102. For example, the dynamic scheduling service 318 may query the promotional data service 322 for data associated with promotional marketing campaign events and dates (which might increase platform 102 user traffic) occurring over a specified time period, such as commercials for sports (or sports-related) events occurring during certain time slots. As another example, the dynamic scheduling service 318 may query the multimedia monitoring service 320 to obtain data associated with social media content on third-party services that may increase user traffic to the platform 102, such as posts (and date information associated with the posts) from rival opponents leading up to a game or match.

The data returned from the event data service 320 (or other services such as services 322-326) may be formatted as a stream of events, in which each event can include information such as sport and/or league, date, time (e.g., start time and end time in a given time zone), description of the event, relevant parties of the event, whether the event is televised, markets in which the event is televised, and so on. The server system 104 may format the stream of data for further evaluation (e.g., by discretizing the data stream into individual events).

In block 506, the server system 104 predicts, based on the event data, events that are likely to increase network traffic to the platform 102 and predict risk windows associated with such events. In some embodiments, the server system 104 may weight each of the events based on whether the underlying event is likely correlative with a high increase in user traffic. The server system 104 may do so based on additional data that serve as indicators of whether a given event correlates with a high increase in user traffic. For example, data provided by the services 320-326 such as market televising information, television ratings data of similar previous events, and weather forecast data can be used to augment predictions that the server system 104 may generate. The server system 104 may evaluate a weighted event against a specified threshold, such that events falling below the threshold are removed from further evaluation for peak traffic periods.

The server system 104 may determine a risk window (e.g., a peak traffic period) as corresponding to a window of time that incorporates a start time and end time of a given event, in which the event has been identified by the server system 104 as likely to drive traffic to the platform 102. The start time of the window may be set earlier than the event start time, e.g., to account for users engaging with the platform 102 prior to the event. Similarly, the end time of the window may be set earlier than the event end time, e.g., to account for events running past the scheduled time (e.g., due to delays or overtime).

In block 510, the server system 104 may determine adjustments in configuration settings for the resource optimization tools 312 based on the predicted peak traffic windows and adjustment rules 414. The server system 104 may do so based on a variety of factors, such as the length of the time window, resource demands for previous similar events (e.g., events that have same teams involved, events that have certain athletes involved, events being televised by certain channels and/or markets, etc.). The determination may also identify specific resource optimization tools 312 having behavior to be modified based on the aforementioned factors and specific configurations 314 to be modified to effect such behavior. Once determined, the server system 104 may store the determined adjustments for a given predicted window for later use.

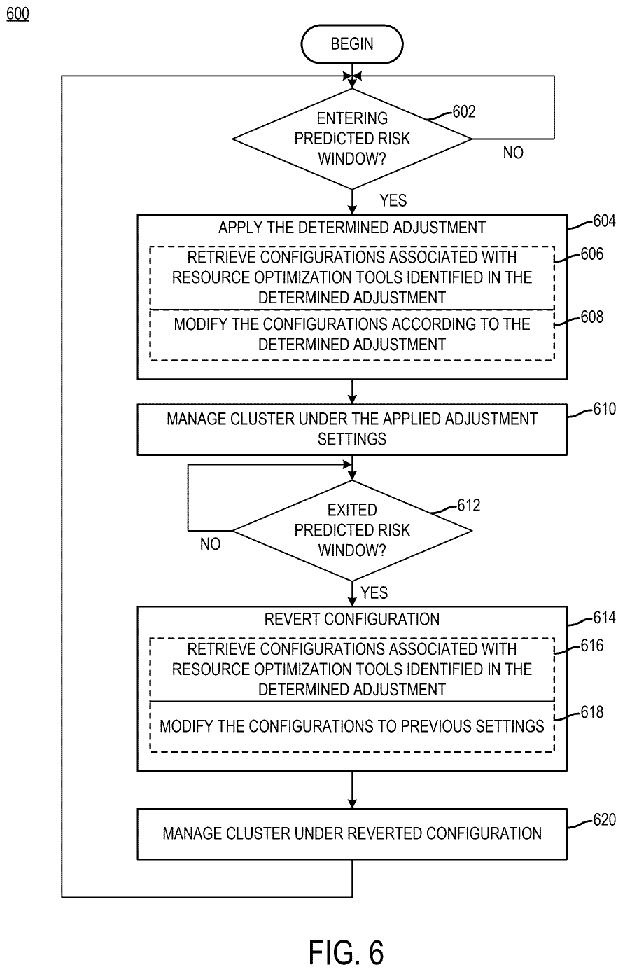

Referring now to FIG. 6, the server system 104, in operation, may perform a method 600 for managing behavior of the resource optimization tools 312 in the platform 102. The method 600 may be performed by a variety of components of the server system 104, such as the platform application 106 and its components, such as the dynamic scheduling service 318 and resource optimization tools 312.

As shown, the method 600 begins in block 602, in which the server system 104 determines whether the platform 102 has entered one of the risk windows (e.g., based on a current time value provide by a system clock of the platform 102). If so, then in block 604, the server system 104 applies the determined adjustment. For example, to do so, in block 606, the dynamic scheduling service 318 retrieves relevant configurations 314 for resource optimization tools 312 identified in the determined adjustment. For instance, the server system 104 may identify a NodePool definition object corresponding to a node cluster having one or more node configurations to be modified. The object may include parameters such as disruption budgets, which can be fine-tuned to mitigate consolidation behavior of the resource optimization tools 312 such as node churn (e.g., frequent cycling of nodes 316 to consolidate workloads causing operational overhead and deployments to have a higher frequency of reduced capacity). The server system 104 may also identify density parameters to be modified for a given node (e.g., to configure a number of workloads for a single node to perform). In block 608, the dynamic scheduling service 318 modifies the configurations 314. For example, the server system 104 may modify one or more fields within the NodePool definition object to reflect the determined configuration adjustment. To illustrate, assume that a major sporting event has been predicted to drive peak traffic to the platform 102. Such traffic may necessitate full capacity of the node cluster 315. During typical operation, the resource optimization tools 312 might trigger node churn due to default bin-packing strategies which aim for optimal resource utilization. The resource optimization tools 312 continuously optimize node usage by provisioning and deprovisioning nodes based on workload demands. However, disruption budgets may be set by default at a given value, such as 25% maximum for pods to be unavailable at any given time to ensure service availability. If the resource optimization tools 312 aggressively and constantly deprovisions nodes during peak traffic, the application 106 can experience degraded service quality without further tuning of the disruption budget. Consequently, existing pods might be evicted and the application 106 may run at less than full capacity. As such, the server system 104 may determine that tuning certain parameters of the resource optimization tool 312 (e.g., Price Capacity Optimization Allocation Strategy) during the time window, node churn can be reduced.

In block 610, the server system 104 manages the cluster 315 under the applied adjustment. For example, the control plane 304 may instantiate the resource optimization tools 312 with the modified configurations 314. The modified configurations 314 causes the resource optimization tools 312 to operate under the modified settings. For instance, assume that one of the determined adjustments corresponds to modifying node disruption budgets. While in the predicted window, the resource optimization tools 312, under the modified budgets, are configured to not force node disruptions even in response to observed increases in traffic.

In block 612, the server system 104 determines whether the platform 102 has exited the risk window (e.g., based on a current time provided by the system clock, based on a set timer elapsing, etc.). If so, then in block 614, the server system 104 reverts to the previous resource optimization tool configuration. For example, in block 616, the server system 104 retrieves the configurations 314 previously modified based on the determined adjustment. In block 618, the dynamic scheduling service modifies the retrieved configuration 314 to reflect the settings in the previous, non-peak traffic conditions. In block 620, the server system 104 manages the node cluster under the configuration.

For the purposes of promoting an understanding of the principles of the present disclosure, reference is made herein to preferred embodiments and specific language is used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

Articles “a” and “an” are used herein to refer to one or to more than one (i.e. at least one) of the grammatical object of the article. By way of example, “an element” means at least one element and can include more than one element.

“About” is used to provide flexibility to a numerical range endpoint by providing that a given value may be “slightly above” or “slightly below” the endpoint without affecting the desired result.

The use herein of the terms “including,” “comprising,” or “having,” and variations thereof, is meant to encompass the elements listed thereafter and equivalents thereof as well as additional elements. As used herein, “and/or” refers to and encompasses any and all possible combinations of one or more of the associated listed items, as well as the lack of combinations where interpreted in the alternative (“or”).

Moreover, the present disclosure also contemplates that in some embodiments, any feature or combination of features set forth herein can be excluded or omitted. To illustrate, if the specification states that a complex comprises components A, B and C, it is specifically intended that any of A, B or C, or a combination thereof, can be omitted and disclaimed singularly or in any combination.

Unless otherwise defined, all technical terms used herein have the same meaning as commonly understood by one of ordinary skill in the art to which this disclosure belongs.

Another aspect of the present disclosure is a system. The system can be implemented in hardware, software, firmware, or combinations of hardware, software and/or firmware. In some examples, the system and methods described in this specification may be implemented using a non-transitory computer readable medium storing computer executable instructions that when executed by one or more processors of a computer cause the computer to perform operations.

Another aspect of the present disclosure provides all that is described and illustrated herein.

One skilled in the art will readily appreciate that the present disclosure is well adapted to carry out the objects and obtain the ends and advantages mentioned, as well as those inherent therein. The embodiments of the present disclosure described herein are presently representative of preferred embodiments, are examples, and are not intended as limitations on the scope of the present disclosure. Changes therein and other uses will occur to those skilled in the art which are encompassed within the spirit of the present disclosure as defined by the scope of the claims.

No admission is made that any reference, including any non-patent or patent document cited in this specification, constitutes prior art. In particular, it will be understood that, unless otherwise stated, reference to any document herein does not constitute an admission that any of these documents forms part of the common general knowledge in the art in the United States or in any other country. Any discussion of the references states what their authors assert, and the applicant reserves the right to challenge the accuracy and pertinence of any of the documents cited herein. All references cited herein are fully incorporated by reference, unless explicitly indicated otherwise. The present disclosure shall control in the event there are any disparities between any definitions and/or description found in the cited references.

1. A system comprising:
one or more processors; and
a memory storing a plurality of instructions, which, when executed on the one or more processors, causes the system to:
retrieve schedule data associated with a plurality of events by polling an application programming interface (API) of one of a plurality of internal services of a platform, each event occurring between a future start time and end time, the platform comprising a plurality of nodes and at least one resource optimization tool configured to optimize utilization of one or more computing resources of the platform;
retrieve historical data associated with the platform by polling an API of another one of the plurality of internal services on the platform, the historical data comprising prior betting activity, platform engagement, and utilization of the one or more computing resources relating to each of the plurality of events;
predict, based on a weighting of the schedule data and on the historical data, one or more of the plurality of events having a likelihood of increasing user traffic to the platform;
identify a time window associated with each of the predicted one or more events;
modify, prior to entering the identified time windows, one or more configuration parameters of at least one resource optimization tool from pre-time window settings to temporary settings to adjust operation of the resource optimization tool during the identified time windows and minimize a risk of disruption to the plurality of internal services of the platform during the identified time windows, wherein to modify the one or more configuration parameters comprises to adjust at least one of a pod disruption budget, a node churn threshold, a bin-packing density parameter, or a dynamic scaling aggressiveness parameter of a resource optimization tool configured to control pod scheduling or node provisioning within the platform;
upon entering one of the identified time windows, execute the at least one resource optimization tool under the modified one or more configuration parameters; and
upon exiting the one of the identified time windows, restore the one or more configuration parameters to the pre-time window settings.

2. The system of claim 1, wherein the schedule data associated with the plurality of events comprises sports event schedules.

3. The system of claim 2, wherein the prediction of the one or more of the plurality of events is further based on a weighting as a function of data from at least one of a promotional marketing data, television ratings data, social media content, athlete information, or sports team rankings.

4. The system of claim 1, wherein the time window incorporates the future start time and end time of the respective event.

5. The system of claim 1, wherein the platform is a cluster architecture, and wherein the at least one resource optimization tool is configured to optimize node provisioning and deprovisioning.

6. The system of claim 5, wherein the configuration parameters of the at least one resource optimization tool comprises at least one of density, cost optimization, or node disruption budget.

7. (canceled)

8. A computer-readable storage medium storing a plurality of instructions, which, when executed by one or more processors, causes a system to:
retrieve schedule data associated with a plurality of events by polling an application programming interface (API) of one of a plurality of internal services of a platform, each event occurring between a future start time and end time, the platform comprising a plurality of nodes and at least one resource optimization tool configured to optimize utilization of one or more computing resources of the platform;
retrieve historical data associated with the platform by polling an API of another one of the plurality of internal services on the platform, the historical data comprising prior betting activity, platform engagement, and utilization of the one or more computing resources relating to each of the plurality of events;
predict, based on a weighting of the schedule data and on the historical data, one or more of the plurality of events having a likelihood of increasing user traffic to the platform;
identify a time window associated with each of the predicted one or more events;
modify, prior to entering the identified time windows, one or more configuration parameters of at least one resource optimization tool from pre-time window settings to temporary settings to adjust operation of the resource optimization tool during the identified time windows and minimize a risk of disruption to the plurality of internal services of the platform during the identified time windows, wherein to modify the one or more configuration parameters comprises to adjust at least one of a pod disruption budget, a node churn threshold, a bin-packing density parameter, or a dynamic scaling aggressiveness parameter of a resource optimization tool configured to control pod scheduling or node provisioning within the platform;
upon entering one of the identified time windows execute the at least one resource optimization tool under the modified one or more configuration parameters; and
upon exiting the one of the identified time windows, restore the one or more configuration parameters to the pre-time window settings.

9. The computer-readable storage medium of claim 8, wherein the schedule data associated with the plurality of events comprises sports event schedules.

10. The computer-readable storage medium of claim 9, wherein the prediction of the one or more of the plurality of events is further based on a weighting as a function of data from at least one of a promotional marketing data, television ratings data, social media content, athlete information, or sports team rankings.

11. The computer-readable storage medium of claim 8, wherein the time window incorporates the future start time and end time of the respective event.

12. The computer-readable storage medium of claim 8, wherein the platform is a cluster architecture, and wherein the at least one resource optimization tool is configured to optimize node provisioning and deprovisioning.

13. The computer-readable storage medium of claim 12, wherein the configuration parameters of the at least one resource optimization tool comprises at least one of density, cost optimization, or node disruption budget.

14. (canceled)

15. A method comprising:
retrieving, by one or more processors, schedule data associated with a plurality of events by polling an application programming interface (API) of one of a plurality of internal services of a platform, each event occurring between a future start time and end time, the platform comprising a plurality of nodes and at least one resource optimization tool configured to optimize utilization of one or more computing resources of the platform;
retrieving historical data associated with the platform by polling an API of another one of the plurality of internal services on the platform, the historical data comprising prior betting activity, platform engagement, and utilization of the one or more computing resources relating to each of the plurality of events;
predicting, based on a weighting of the schedule data and on the historical data, one or more of the plurality of events having a likelihood of increasing user traffic to the platform;
identifying a time window associated with each of the predicted one or more events;
modifying, prior to entering the identified time windows, one or more configuration parameters of at least one resource optimization tool to adjust operation of the resource optimization tool during the identified time windows and minimize a risk of disruption to the plurality of internal services of the platform during the identified time windows, wherein modifying the one or more configuration parameters comprises adjusting at least one of a pod disruption budget, a node churn threshold, a bin-packing density parameter, or a dynamic scaling aggressiveness parameter of a resource optimization tool configured to control pod scheduling or node provisioning within the platform;
upon entering one of the identified time windows, executing the at least one resource optimization tool under the modified one or more configuration parameters; and
upon exiting the one of the identified time windows, restore the one or more configuration parameters to the pre-time window settings.

16. The method of claim 15, wherein the schedule data associated with the plurality of events comprises sports event schedules, and wherein the prediction of the one or more of the plurality of events is further based on a weighting as a function of data from at least one of a promotional marketing data, television ratings data, social media content, athlete information, or sports team rankings.

17. The method of claim 15, wherein the time window incorporates the future start time and end time of the respective event.

18. The method of claim 15, wherein the platform is a cluster architecture, and wherein the at least one resource optimization tool is configured to optimize node provisioning and deprovisioning.

19. The method of claim 18, wherein the configuration parameters of the at least one resource optimization tool comprises at least one of density, cost optimization, or node disruption budget.

20. (canceled)
